(19) United States
(12) Patent Application Publication
(10) Pub. No.: US 2020/0097479 A1
(43) Pub. Date: Mar. 26, 2020

(54) SYSTEM AND METHOD OF MERGING TWO DISPARATE ELECTRONIC DATABASE STRUCTURES FOR MONITORING AND TRACKING ROBOTIC SYSTEMS INTO A NEW DATABASE STRUCTURE

(71) Applicant: ARIIX LLC, Bountiful, UT (US)

(72) Inventors: Fred William Cooper, Farmington, UT (US); Riley Paul Timmer, South Jordan, UT (US); Wenhan Zhang, Draper, UT (US)

(21) Appl. No.: 16/697,910

(22) Filed: Nov. 27, 2019

Related U.S. Application Data
(63) Continuation-in-part of application No. 14/024,228, filed on Sep. 11, 2013, now abandoned.
(60) Provisional application No. 61/700,095, filed on Sep. 12, 2012.

(51) Int. Cl. G06F 16/25; G06F 16/22

(52) U.S. Cl. CPC G06F 16/25; G06F 16/2246

(57) ABSTRACT

Computers for enabling an entity such as a robot to build other robots that are deployed into service and have a system for tracking performance through a tracking tree of essentially any width or depth and to receive tracking data for the entire width and depth of the tracking tree. In some embodiments, building the multi-line tracking plan includes transitioning an entity's existing tracking plan that is limited in width, depth or width and depth to a new tracking plan that is unlimited in width and depth. In some embodiments, computers can cause an entity to re-enter the tracking tree, within one or more downlines, thereby providing new tracking positions for the same entity within a single tracking tree. Embodiments may include computer systems that auto-balance volume that is generated from the downlines, such that the volume is placed where it would generate the greatest amount of tracking data for a sponsoring entity.

### CROSS-REFERENCE TO RELATED APPLICATIONS

The present application is a continuation-in-part of U.S. application Ser. No. 14/024,228, filed on Sep. 11, 2013, which claims priority to U.S. Provisional Application No. 61/700,095 filed on Sep. 12, 2012, the disclosure of which are incorporated herein by reference in their entirety.

### BACKGROUND OF THE INVENTION

### 1. Field of the Invention

The present disclosure generally relates to database system merging and management of data records and protocols stored therein. The disclosure also relates to managing the tracking of the performance of robots and robots created by other robots and more specifically to an approach to merging a first physical, electronic database structure designed for tracking the performance of robots created by other robots according to a first framework with a second physical, electronic database structure designed for track the performance of robots created according to a second framework to form a new physical, electronic database structure that maintains the first framework and the second framework in terms of a tracking system to determine how well robots in each generation of one or more generations, including the first generating robot, perform.

### 2. Introduction

In the advancing world of robots, the use and application of robots for many different tasks is constantly expanding. In many scenarios, a manufacturing robot will literally build other robots that can perform tasks such as moving items around a warehouse, performing tasks in a hospital scenario, or even building other robots.

It is desirable to track the performance of such robotic families and even into multiple generations. For example, as shown in FIG. 1A, family of robots 100 can be created in which a first robot 102 may create a second robot 104 which is also programmed to create third robot 110. The second robot 104 may create large number of robots 112, 114, etc., as well. A first framework can be structured and which the first robot 102 will create a large number of second robots 104, 106, 108 each of which can create third robots 110, 112, 114 and wherein the third robots will perform tasks other than creating additional robots. The framework 100 can be described in a number of different ways. One example is a unilevel framework in which there is a finite depth (one level or maybe two levels) but a large width with respect to how many second robots 104, 106, 108 can be created. The depth is limited inasmuch as the second generation robots 104, 106, 108 or the third generation robots 110, 112, 114 do not create additional robots. With each generation of robots, technical errors or physical irregularities can be introduced into the robot structure outside of design specifications. Thus, a second or third generation robot may experience more mechanical failure than a first generation robot in terms of performance, endurance, or accuracy in performing certain functions such as welding, 3D printing, and so forth. In view of the potential for multi-generational errors or successes, there can be a framework developed for rewarding robots or owners of robots who build other robots that perform well. Tracking data can be associated with performance and can be comprise any number of different formats such as money, tracking data associated with performance, awards, or other indicators of success or appreciation.

Often, it is desires to track and reward robots in a specific down line between an originating robot, its child robot, and its particular grandchild robot. The system can identify successful lines within the genealogical structure with respect to performance and tracking data.

A physical, electronic database structure 122/124 can track the performance of one or more of the first robot 102, each of the second robots 102, 106, 108 and each of the third robots 110, 112, 114 over a network such as the Internet 120. Tracking data or points in a database can be provided for successful tasks, a lack of down time, or any other parameter associated with each respective robot in any generation. In such a system, the performance of the first robot 102 relative to the second layer of robots 104, 106, 108 and the third layer robots 110, 112, 114 can be tracked, reported and/or rewarded according to the unilevel framework. For example, if robots 110, 112, 114 perform well, the first robot 102 can be rewarded or its owner can receive a payment or reward of some sort.

In another example 130 shown in FIG. 1B, a first robot 132 might be programmed to build 5 robots as a first generation 134, 136, 138, 140, 142. Each of those 5 robots might be programmed to build one additional robot in a second generation 144, 146, 148, 150, 152. Each of the robots and the second generation can be programmed to build one (and only one) additional robot and the third generation. This framework 130 could be called a matrix framework with a finite width and a finite depth. Again, within the second framework 132, a physical, electronic database structure 154/156 can be implemented to track tasks and tracking data across generations associated with each respective robot over a network 120 and to provide that data in some manner to evaluate the performance of the overall system 130. As there is a genealogical structure, points, tracking data or value can be incorporated into the reporting and allocation system. For example, if all of the first, second and third generation of robots performs a high level, with little down time, then the first robot can be scored at a higher rate to indicate its success or the success of its child and grandchildren robots. Other framework structures can include a binary structure which is of a finite width but infinite depth as well as a multiline structure which would have infinite width and infinite depth.

The database 124 and the database 156 and associated control systems 122, 154 (servers or control systems for managing the monitoring or tracking of the different generations of robots and their performance and tracking data) might need to be merged for various reasons. A unilevel system from one warehouse might need to be moved to another warehouse where a multi-level or multi-line structure is in place with multiple generations of robots. However, inasmuch as the internal structure of these different databases and control systems are different in nature, it becomes a complicated process to maintain the data and tracking functions for different types of frameworks in a blended database.

In one example, the challenge can arise if a company operating a unilevel robotic framework desires to merge with the company operating a matrix type robotic framework, then the respective physical, electronic database structures are not easily combined in order to maintain the respective frameworks. If these companies were to merge such that all of the robots are now operating under the same corporate framework, and the systems were to be blended, these respective physical, electronic database structures are configured differently and provide feedback, points, tracking data or valuations differently according to the respective frameworks. The challenge a blending such databases might prevent an appropriate consolidation of companies with the respective robotic systems because the consolidation of such disparate database systems might be too expensive or too complicated to achieve.

### SUMMARY

This disclosure relates to database system merging and the management of database records and structures or a framework for tracking multigenerational performance and providing tracking data. What is needed in the art is a new special purpose computer system which can receive a first physical, electronic database structure according to a first framework for tracking the performance and corresponding tracking data of multiple generations of entities and receive a second physical, electronic database structure according to a second framework for tracking the performance and corresponding tracking data of multiple generations of entities and to perform specific tasks in order to create a new physical electronic database structure that is stored in a computer readable device as a new database and which can maintain the characteristics of the respective first framework and the second framework while being merged into a single database.

The entities in one primary example can be robots but could also apply to any entity in which one or more generations of child entities are created or commissioned, deployed and their performance is tracked and rewarded intergenerationally. For example, in a robot scenario, a tracking tree stored in the first physical electronic database could manage the performance for a first generation of robots that were built by a parent robot or robots. The data such as tasks accomplished, down time, repair requirements and costs, robot efficiency, energy used, and so forth could be built into a tracking data approach in which the manufacturer or parent robot or robots could receive tracking data of some kind as a characterization of the performance of the robots which they created. The tracking tree can be configured for a particular single or more of multigenerational family of robots. Another tracking tree can be configured for different types of multigenerational structure. This disclosure provides an approach to blending the two different types of tracking trees and associated electronic and physical databases using a special purpose computer system particularly applying a specific set of steps to maintain the characteristics of differently structured tracking trees and resulting single new tracking tree.

An example method embodiment includes one or more of the steps of (1) identifying a first tracking tree stored on in a first physical, electronic database as a first physical, electronic data structure stored on a first computer readable medium of a first database system, (2) identifying interconnected nodes represented in the first tracking tree of the first database system, the interconnected nodes representing separate first positions of separate entities of the first database system and the interconnected nodes being connected to one another within a first genealogical structure with connections between the interconnected nodes representing genealogical relationships between the entities, the first genealogical structure being a unilevel, matrix, or binary genealogical structure and first tracking tree having a first state of being of a limited width or of a limited depth, (3) mapping the interconnected nodes represented in the first physical, electronic data structure of the first database system to second nodes of a second tracking tree stored in a second physical, electronic database as a second physical, electronic data structure on a second computer readable medium of a second database system, the second nodes of the second physical, electronic data structure representing separate second positions of separate entities of the second database system, with connections between the second nodes representing genealogical relationships between the separate entities of the second database system, the second tracking tree having a multi-line genealogical structure reasonably unbounded in width or depth.

The mapping can include forming a new connection between at least one node of the first physical, electronic data structure with at least one node of the second physical, electronic data structure to merge the first physical, electronic data structure into the second physical, electronic data structure, to yield a new tracking tree represented as a new physical, electronic data structure stored in a third computer readable medium as a new database and in a second state of being reasonably unlimited in width and depth.

The new connection can represent the formation of a genealogical relationship between at least one entity of the first database system and at least one entity of the second database system, wherein, as a result of the multi-line genealogical structure of the second physical, electronic data structure, the mapping is performed without disrupting parent/child relationships within the first or second tracking trees. In another aspect, the first database system can be separate from the computer system and separate from the second database system. The method further can include (4) adding one or more re-entry points for a particular entity into the second physical, electronic data structure of the second database system, the one or more re-entry points representing one or more positions within the genealogical structure of the second physical, electronic data structure of the second database system, wherein at least one of the one or more re-entry points is added at a location within the genealogical structure that does not directly descend from another position of the particular entity, (5) determining points or tracking data generated for a given time period, the points or tracking data representing a value of a particular entity in the second database system, (6) when a single entity has more than one position, placing points or tracking data in each of the positions of the single entity by at least calculating the points or tracking data required to optimize each individual position of the single entity and creating a list by ordering all the positions of the single entity in ascending order based on total points or tracking data in each position of the single entity and ordering two or more positions having the same amount of points or tracking data in descending order based on a level of the position within the respective first or second tracking tree, (7) automatically identifying tracking lines in the new physical, electronic data structure in the second state of being reasonably unlimited in width and depth to yield identified tracking lines and (8) electronically transferring, via a specialized computing system having hardware components that implement transactions, a benefit to respective individual accounts for each respective entity according to the new physical, electronic data structure and the identified tracking lines. In one aspect, the entity is a robot or robots but could also be a person or some other entity. The benefit can be represented as points, tracking data, rewards, money or other benefit.

Embodiments may include computers for enabling a distributor to build a tracking tree of essentially any width or depth and to receive reward for the entire width and depth of the tracking tree.

Embodiments may include special purpose computers with functionality for building and using a multi-line tracking plan that is unlimited in width and unlimited in depth, as well as embodiments for rewarding entities of the tracking plan. In some embodiments, building the multi-line tracking plan includes transitioning an entity's existing tracking plan that is limited in width, depth or width and depth to a new tracking plan that is unlimited in width and depth. For instance, in some embodiments, an existing binary plan, unilevel plan or matrix plan that is embodied in an electronic database and/or control algorithm is mapped into or converted into a new tracking plan (unconstrained by width or depth) that enables the primary entity to continue to develop the tracking tree in width and/or depth and to receive rewards or tracking data for downlines that would not be available under the previous binary, unilevel or matrix plan from which the new tracking plan is developed. The new multi-line tracking plan provides for an unlimited potential number of pay lines (downlines) per position.

In some embodiments, computers can cause an entity to re-enter the tracking tree, within one or more downlines, thereby providing new positions for the same entity within a single tracking tree.

Embodiments of the disclosure may include computer systems that auto-balance volume that is generated from the downlines, such that the volume is placed where it would generate the greatest amount of rewards, tracking data or credits for a sponsoring entity.

These and other features of various embodiments of the present disclosure will become more fully apparent from the following description and appended claims, or may be learned by the practice of the disclosure as set forth hereinafter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1A illustrates an example of multiple generations of robots created and deployed to perform certain tasks according to one framework;

FIG. 1B illustrates an example of multiple generations of robots created and deployed to perform certain tasks according to another framework;

FIG. 2A illustrates a flow chart illustrating auto balancing for a single tracking position;

FIG. 2B illustrates a flow chart illustrating auto balancing for multiple tracking positions;

FIG. 3 illustrates one example of a result of an auto balance operation;

FIG. 4 illustrates another example of a result of an auto balance operation;

FIG. 5 illustrates another example of a result of an auto balance operation;

FIG. 6 illustrates a graphical representation of various multi-level tracking systems;

FIG. 7 illustrates various multi-level tracking systems overlaid on a multi-line system;

FIG. 8 illustrates re-entry of different income positions for an entity in a multi-level tracking system;

FIG. 9 illustrates re-entry of a different income position for an entity in a multi-level tracking system that does not follow a hierarchical line to the top level income position for the entity;

FIG. 10 illustrates a method of optimizing tracking data in the multilevel tracking system;

FIG. 11 illustrates a method of optimizing tracking data in the multilevel tracking system;

FIG. 12 illustrates a method of optimizing tracking data in the multilevel tracking system;

FIG. 13 illustrates a first database and a second database being combined by a combining system into a new database structure;

FIG. 14 illustrates a method aspect of this disclosure;

FIG. 15 illustrates a special purpose computer system for receiving a first multi-level tracking system, a second multi-level tracking system, and applying a particular algorithm to each to generate a combined multi-level tracking; and

FIG. 16 illustrates another special purpose computer.

### DETAILED DESCRIPTION

Various embodiments of the disclosure will now be described. In describing these embodiments, various terms will be used. To assist in understanding the described embodiments, some of those terms will now be defined. The following terms are used with respect to a particular reward scheme of one embodiment for providing tracking data based on entity performance multi-generationally. The terms may be applied differently in different tracking and rewarding schemes in the context of multi-level robot systems in which robots build other robots and deploy them for service in one or more generations.

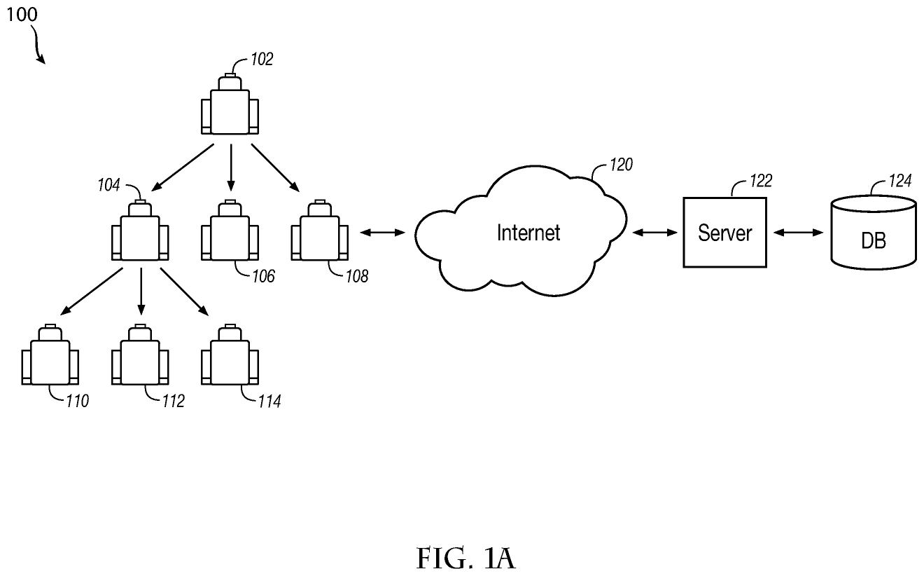

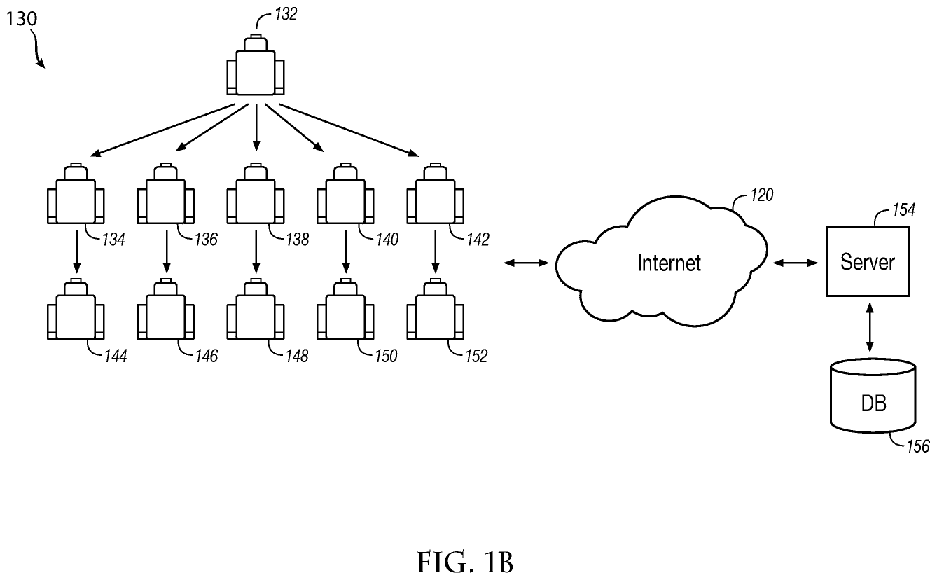

FIG. 1A illustrates an aspect of this disclosure focused on multigenerational robotic systems. The framework 100 involves multiple generations of robots. An initial originating robot 102 generates child robots 104, 106, 108. These can be any kind of robots, for example, that may work in a warehouse, sort items, build cars, deliver medicines, build other robots, and so forth. Typically, each of robots 104, 106, 108 will be deployed to perform certain tasks. In some cases, these tasks might include building other robots. Robot 104 is shown as building the next generation of robots 110, 112, 114. Part of this disclosure involves the management and tracking of the success or the performance of these multiple generations of robots and providing associated tracking data to parent or grandparent robots or the owners thereof. For example, data associated with the performance, down time, success rates, efficiencies, achievements, and so forth can be provided via the Internet 120 to a backend server 122 that can evaluate, track and reward one or more entity in connection with the performance of the multiple generations of robots. An electronic database 124 can maintain the data and can also be used to structure a tracking framework for these robots. For example, in one aspect, assume the creating robot 102 only creates a single generation of robots 104, 106, 108 and each one of these may have specific tasks to perform that do not include building an additional generation of robots. Such a unilevel framework can have a tracking and rewarding scheme that can be implemented by the server 122 and database 124 within that framework.

FIG. 1B illustrates another example where a creating robot 132 creates a first generation of robots 134, 136, 138, 140, 142. Each of these robots builds one or more of a next generation of robots 144, 146, 148, 150, 152. There might be additional generations as well. This can be a multilevel generational framework with a limited width but no limit on the depth. There can be a different tracking and reward framework knowing that multiple generations down the line could represent a grandchild or great-grandchild robot that may have different issues with respect to its down time, productivity, efficiencies, and so forth. Data can be communicated to the Internet 120 and provided to a server 154 in connection with electronic database 156 to track the performance and provide tracking associated with each robot in each respective generation. In one aspect, for example, if robot 152 performs well, a point system can be provided to grant points to that robot as well as its parent robot 142 and its grandparent robot 132. In this manner, the individual progress and characteristics of each robot within the multiple generations can be tracked and identified and problems or technical issues can be also identified where some particular family line or individual robot may need to be taken off line due to the lack of performance for the robot itself or children or grandchildren robots.

Known tracking plans for multi-level tracking and rewarding systems can include unilevel plans, matrix plans and binary plans.

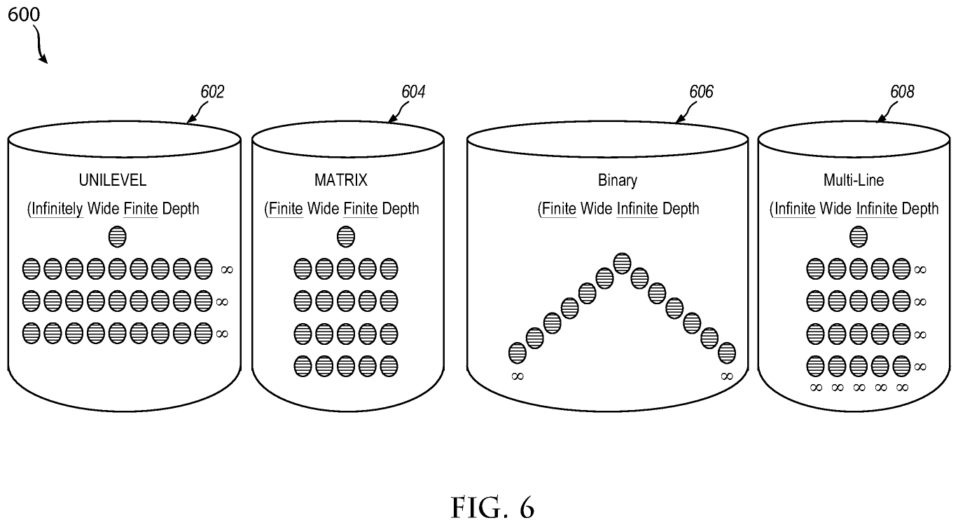

In unilevel plans, a primary entity has a single frontline of sponsored entities that are directly beneath the primary entity in a tracking tree. There can be an unlimited number of frontline entities in this type of plan. The primary entity will earn rewards such as tracking data off of each frontline entity and that entity's downline, i.e. entities beneath a frontline entity, but limited to a predetermined depth. Accordingly, unilevel plans are characterized as providing tracking data associated with performance for tracking trees of essentially infinite width, but only finite depth. This database framework is shown as feature 602 in FIG. 6.

Binary plans 606 are almost the exact opposite of unilevel plans. In binary plans, a primary entity is only allowed a limited number of frontline entities, but the primary entity will receive tracking data for the entire downline of each frontline entity and the downline depth is not limited. An electronic, physical database structure for implementing a binary plan 606 is shown in FIG. 6. Accordingly, binary plans are characterized as providing commissions for tracking trees of finite width, but essentially infinite depth.

Matrix plans include some aspects of unilevel plans and binary plans, namely a finite width and a finite depth 604, shown as a database framework in FIG. 6. Matrix plans have a limited number of entities who can be placed on each entity's downline and there is a limited depth for each downline that the entity will earn tracking data off of.

There is currently a need for improved tracking plans, and automated systems to improve tracking plan structures, that are not limited by the width or the depth of the tracking tree for which an entity is rewarded.

The term “Auto-Balance” generally relates to the use of a unique algorithm and system for placing performance volume in a manner that will generate the most amount of tracking data possible to an entity.

The term “Bonus” generally refers to additional tracking data provided to entities. This can be done for achieving higher levels of performance volumes on a line or by achieving higher numbers of lines, or for other appropriate reasons.

The term “Bucket” generally refers to points that are accumulated from the purchases of entities and additional orders of entities that are available for auto-balancing.

The term “Cycle” generally refers to a given time period For example, a cycle may be a period of 4 weeks (28 days). Although other cycles can also be used.

The term “Income Position” or “(IP)” generally refers to the location on a genealogical path in a tracking tree.

The term “Optimization” generally refers to earning the maximum amount of tracking data on any single pay line.

The term “Payline” or “(PL)” generally refers to the second, third, or more lines in a downline that generate volume and subsequent tracking data for entities. As noted below, the first line is the powerline. The powerline, in the illustrated example, does not generate tracking data for entities.

The term “Point” generally refers to a credit value. Some embodiments equate a single point to $1 US and corresponding valuation for other currencies based on exchange rates against the US Dollar. However, other point valuations can also be used. Points can be achieved, for example, by an entity personally performing a task or by certain entities performing other tasks.

The acronym “POIP” refers to points that are auto-balanced to an Income Position to optimize a single payline per income position.

The acronym “POPL” refers to points that are auto-balanced to an Income Position to optimize more than one payline.

The term “Powerline” generally refers to a line in a downline that that does not generate tracking data for entities. In the example illustrated below, the powerline is the line that accumulates the highest number of points.

The acronym “W1P” refers to “Where 1 point” and generally relates to the process in Auto-balancing where volume points are placed ($1=1 point) 1 point at a time in an entity's tree structure, such that tracking data are maximized in regards to the rules of the tracking plan, assuring that volume is placed where tracking data are maximized for a given period.

It is noted that the primary framework outlined herein is for the tracking and rewarding of multigenerational robots for the purpose of evaluating technical accuracy efficiency and performance. The tracking data can be based on points that can be then used for evaluate whether a parent or grandparent robot and its children or grandchildren are performing well and thus should be rewarded. These principles could also apply to other multi-generational tracking and performance systems such as multilevel tracking and reward systems in which distributors, downline entities, and customers all interact in a way in which performance of an entity within this framework can impact tracking data or commissions paid to a parent or grandparent entity within a particular genealogical structure. The disclosure now turns to an auto balancing approach.

### Auto Balancing

In the illustrated example which can relate to a multi-level tracking and reward framework, an entity needs a certain number of performance achievements in a given cycle to qualify for any tracking data. For example, a robot may need to have perfect performance from its downline robots in order to earn a reward. A line generating the most points is the power line and does not pay any reward. Any other paylines, in the illustrated example, have a maximum $2,000 reward paid at 15% of generated points. Thus, 13,334 generated points will result in the maximum reward for a payline. All volume generated from either personal successes or from volume for entities below the given entity in excess of the qualification requirements for a cycle is “Auto-Balanced.” The algorithm of this process will guarantee the best placement of each individual point to generate the maximum tracking data earned. The auto balancing framework implemented on a special purpose computer is one example tracking data structure which might need to be combined with a different kind of database structure for some reason.

Single Income Position Auto Balance

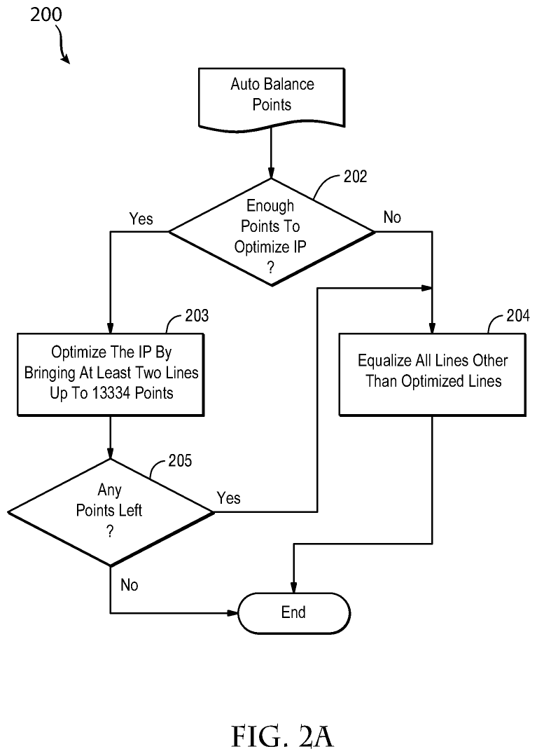

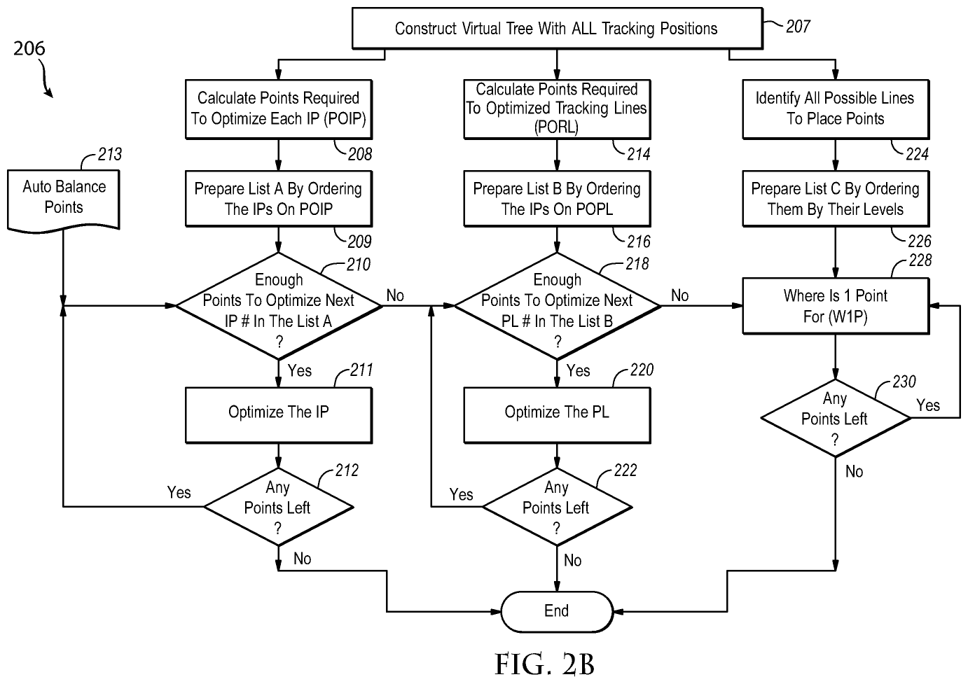

If an entity only has one reward position, a computer system can implement the auto balance process to place the points in the following computer implemented steps. A special purpose computer can include stored instructions for performing the following algorithm 200 as illustrated in FIG. 2A:
1) At act 202, a determination is made as to if there are enough points to optimize a reward position. If there are enough points to optimize the reward position, the system places all or part of the points in the line(s) to bring them to 13,334, or any other predefined number of points (act 203). In the illustrative example, this will earn a share in a reward position bonus pool, and one or more shares in a pay line bonus pool, if more than three lines are optimized.
2) As illustrated at act 205, a determination is made to determine if any points are left after step 1. If any points are left after fulfilling step 1, as illustrated at act 204, these points will be placed in all available lines other than the optimized lines to best equalize the points across them. This will guarantee a maximum base reward.
3) If at act 202 it is determined by the system that the auto balance points are not enough to fulfill step 1, all points will be placed in all available lines to best equalize the points across all lines, as illustrated at act 204. This will guarantee a maximum base reward.

Multi-Income Position Auto Balance

Referring now to FIG. 2B, an embodiment 206 is illustrated for optimizing income for an entity that has multiple reward positions. If an entity has more than one reward position, as illustrated at act 207, a virtual tree is constructed to only include all the entity's reward positions connected by their genealogical relationship. Rewards or tracking data can also be termed income if the entity applies to an individual instead of a robot. A special purpose computer will implement the auto balance process and will place the points in the following steps:

1) Optimize all reward positions if possible to earn shares in a reward position bonus pool:
a. Calculate the points required to optimize each income position. (POIP) (act 208).
b. Prepare a list (act 209) by ordering all the income positions by POIP in ascending order, level of each income positions in the virtual tree in descending order. Thus, for example, when the system creates a list it will order the list first by the points required to optimize the income positions. This is done in ascending order so that the first income position on the list is the position that requires the smallest number of points to optimize, which leads to the most efficient use of the points available. If two different income positions need the same amount of points, then the positions are then ordered in descending order based on what level they are in the genealogical tree (level one being at the top of the tree). The reason for this is that the points roll up the tree, so if you plug in points at the bottom of the tree (e.g., level 5), it positively affects income positions higher up the tree (e.g., level 2).
c. At act 210, it is determined that if there are enough points to optimize the first income position in the list prepared from step b, then, as illustrated at act 211, embodiments optimize the first income position by placing all or part of the points in the line(s) to bring them to 13,334 in the illustrated example, or any other predefined number of points. This will earn a share in the income position bonus pool.
d. As illustrated at act 212, it is determined that if any points are left after fulfilling step c and enough to optimize the next income position in the list prepared in step b (as illustrated again by act 210), then embodiments optimize the next income position in the list (as illustrated again by act 211) by placing all or part of the points in the line(s) to bring them to 13,334, or any other predefined number of points. This will earn an additional share in the income position bonus pool.
e. Embodiments repeat step d until there are no points left or the points left are not enough to optimize the next income position in the list.

2) If any points left from fulfilling step 1, or the auto balance points (act 213) are not enough to optimize any income positions, embodiments optimize pay lines in the income positions already optimized to earn shares in the pay line bonus pool:
a. As illustrated at act 214, embodiments calculate the points required to optimize pay line(s) in the optimized income position. (POPL)
b. As illustrated at act 216, the system can prepare the list by ordering all the income positions by POPL in ascending order, level of each income positions in the virtual tree in descending order. See 1(b) above.
c. As illustrated at act 218, if the system determines that there are enough points to optimize the pay line(s) in the first income position in the list prepared from step b, then, as illustrated at act 220, the system optimizes the pay line(s) in the first income position by placing all or part of the points in the line(s) to bring them to 13,334, or any other predefined number of points. This will earn a share in the pay line bonus pool.
d. As illustrated at act 222, if the system determines that any points are left after fulfilling step c and enough to optimize the pay line(s) in the next income position in the list prepared in step b, as illustrated again at act 218, then the system optimizes the pay line(s) in the next income position, as illustrated again at act 220, by placing all or part of the points in the line(s) to bring them to 13334, or any other predefined number of points. This will earn additional shares in the pay line position bonus pool.
e. The system repeats step d until there are no points left or the points left are not enough to optimize the next income position in the list.

3) A determination is made that if any points are left after step 1 and/or step 2, or the auto balance points are not enough to fulfill step 1 and/or 2, all points will be placed in the virtual tree by using the method of “where is 1 point good for?” (W1P).
a. As illustrated at 224, the system identifies all possible lines to place points in the virtual tree.
b. As illustrated at 226, the system prepares a list by ordering them by their levels in the virtual tree in descending order.

Act 228 in FIG. 2B now represents steps c through g.
c. The system takes 1 point from the bucket of auto balance points, and place it in the first line prepared in step b,
d. The point is rolled up on the virtual tree and embodiments calculate the total base reward. (c$1)
e. The system changes the point to the next line in the list, and repeat step d. (c$2)
f. The system compares the total rewards c$1 and c$2. If c$1>c$2, then the system keeps the point in line position 1. If c$1<c$2, then the system keeps the point in line position 2.
g. Repeat the step e-f until a given point has been placed in all lines in the list and the best line is determined, which generates the highest reward.
h. Repeat step c-g until all points in the bucket are placed in the virtual tree as determined at act 230.
   After all 3 steps, every point has been placed at the best place possible location where the maximum reward is guaranteed.

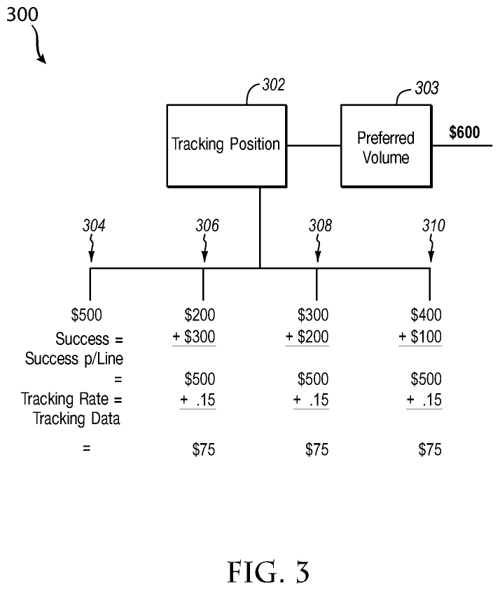

FIGS. 3-5 illustrate several examples of tracking data increased based on point by point placement of sales generated by preferred entities or success of a particular robot. Based on the volume generated by entities, placement and amount of volume varies from week to week, or any other predefined period.

For example, FIG. 3 illustrates a case for a reward position 302 which has a powerline 304 that generated $500 in sales or some other parameter indicates success such as up time for a robot, a first payline 306 that generated $200 in sales, a second payline 308 that generated $300 in sales and a third payline 310 that generated $400 in sales. For the reward position 302, $600 or points were generated by sales to preferred customers, which points can be used to optimize the reward position 302. Because there are not sufficient points to bring both the power line 304 and the first payline 306 up to 13,334 points, the points are instead distributed across the paylines to maximize tracking data. In this case, all paylines can be brought up to $500, exhausting the available points, to match the powerline 304, and thus tracking data are maximized. Again, tracking data can be points, value, or other tracking data for a robot entity or commissions or money in the context of a human in a multilevel tracking plan.

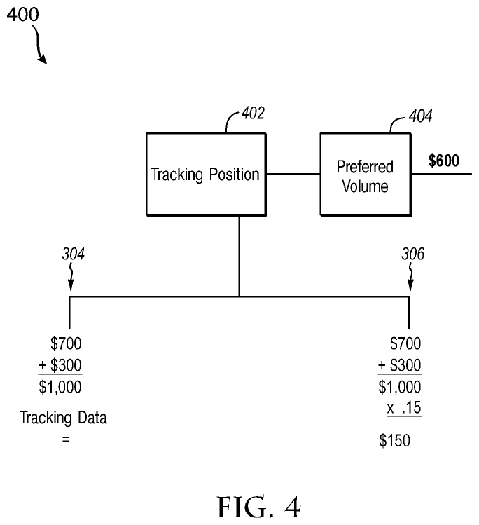

FIG. 4 illustrates an example where for a reward position 402, there are enough points to increase the powerline 404, which also allows for an increase in the payline 406. By causing the powerline 404 and the payline 406 to have equal points, tracking data are maximized.

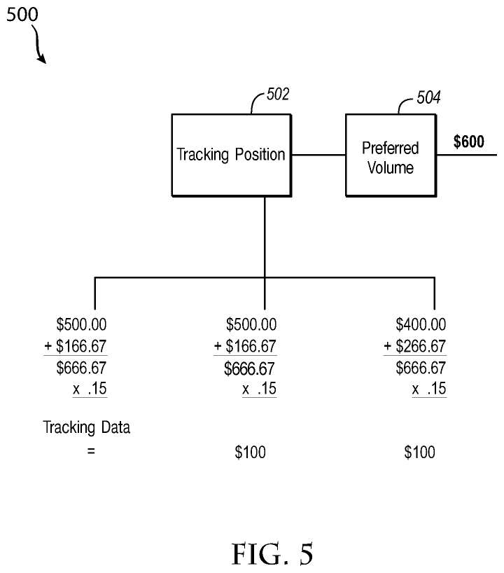

FIG. 5 illustrates an example of a reward position 502, where by using available points, the powerline 504 can be increased by $166.67, which allows a first payline 506 to be increased by $166.67 and a second payline 508 to be increased by $266.67, to maximize tracking data.

### Multi-line Tree Structure

As described above, current tracking systems generally fall within three classifications of placement on entities in a genealogical structure; namely, unilevel, matrix, and binary. Each of these schemes is depicted in the figures in the context of a database structure 600. For example, FIG. 6 illustrates a unilevel tree database structure 602 with infinite width and finite depth. FIG. 6 also illustrates a matrix tree database structure 604 with finite width and finite depth. FIG. 6 also illustrates a binary tree database structure 606 having a finite width, but an infinite depth.

Some embodiments herein implement a “multi-line” trees structure 608 in an electronic, physical database structure. The multi-line tree structure 608 of some systems of the present disclosure allows for generations of tracking data from entities placed in a down-line regardless of the levels down (rows). Furthermore, the database structure allows for commissions or tracking data to be earned on an unlimited number of columns. Accordingly, the present disclosure provides for infinite depth and width, whereas all other types of current structures built into databases or computer systems for implementing such plans have a finite number of either rows (depth) or columns (width) allowed. Embodiments can be used to convert pre-existing structures to the infinite depth and width structure.

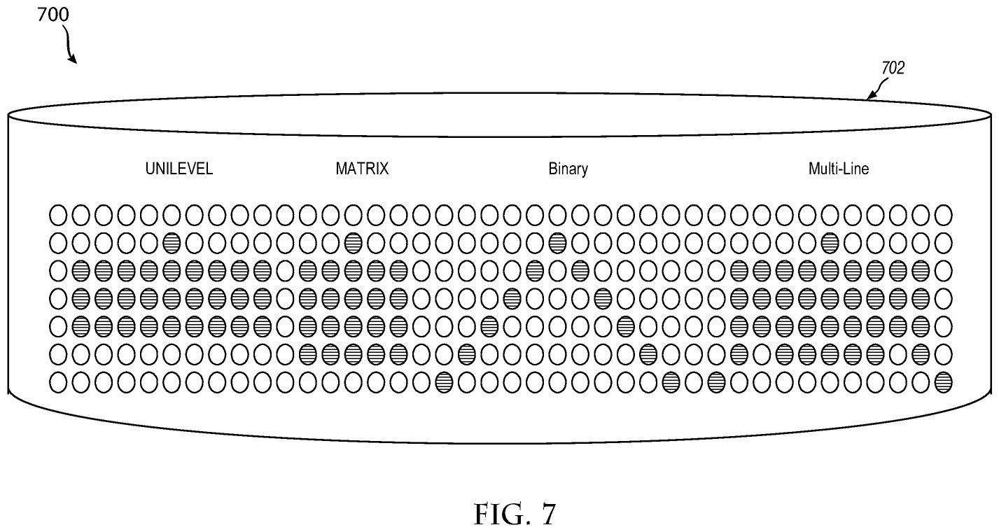

Currently, only the matrix tree structure 604 can be placed into the unilevel tree structure 602 without disrupting the parent/child relationship that exists between two organizations. Furthermore, the binary tree structure 606 cannot be merged into either the unilevel tree structure 602 or the matrix tree structure 604, or vice versa without changing the parent/child hierarchical structure, or in other words, the electronic, physical databases embodying the particular structure. However, given that the multi-line accommodates both plans of infinite depth and width, the technology disclosed herein enables companies can now merge tracking and rewarding plans by adopting the multi-line structure as illustrated below. Alternatively, entities can have their existing tracking plan mapped 700 to the multi-line tracking plan embodied in an electronic, physical database structure, such as is illustrated by FIG. 7, wherein the shaded patterns correspond to positions of existing plans or the new multi-line plan and wherein the new multi-line plan is shown in a database structure 702 that encompasses all of the other previous plans, which are mapped to the multi-line plan.

The shaded positions are actual positions and the un-shaded positions correspond to possible positions within the new multi-line plan(s). Actual positioning can be determined during mapping to ensure actual compensation within the new multi-line plan(s) will at least equal previous tracking data from the another plan being mapped to the new multi-line plan.

### Crossline Re-Entry's

Some tracking plans, (almost exclusively found in the binary) allow for re-entry's. A re-Entry is another position in the genealogical structure owned/occupied by the same individual or entity. Re-entry(s) enable entities to reposition themselves under their current position somewhere in their down-line. The ability to provide tracking data based on placement is important to such structures.

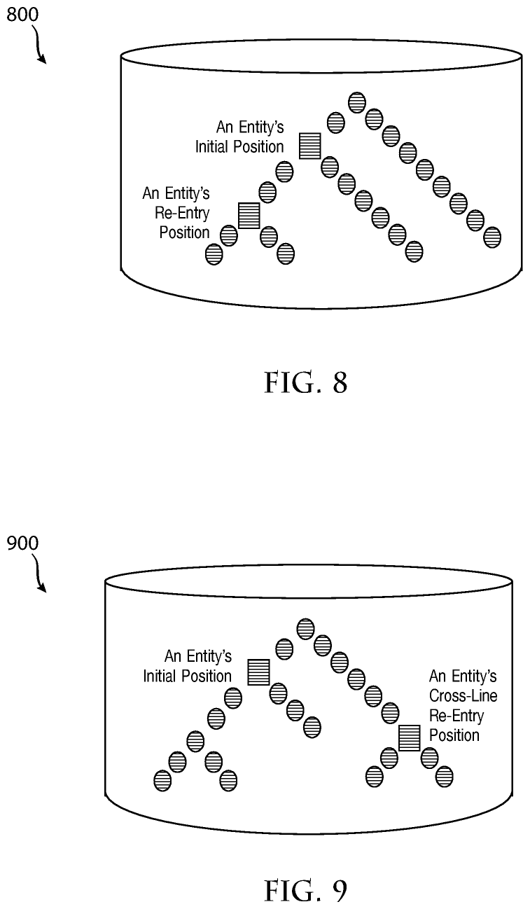

However, until now, in the context of the entity being an individual in a multi-level tracking plan, a single business owner has not been able to build in two separate positions intentionally (some exceptions exist in the case of marriage, or inheritance but even under such circumstances the businesses are treated as two separate businesses in terms of operation, point accumulation and recognition). FIG. 8 depicts how re-entry's are typically placed in a binary framework.

While flexibility is granted where positions are allowed to be placed, all tracking plans generally require that a pathway exists from the bottom of the genealogical tree from one line ultimately up through the initial position. In the multi-line structure, re-entry's are granted and placement is anywhere including cross-line to the initial reward position, such as that illustrated in FIG. 9. Cross-line placement is the distinguishing characteristics since any volume which flows through a re-entry that is cross-line to the initial reward position would not have sales volume flow through both reward positions.

By allowing infinite depth and width, re-entry's are allowed to be placed anywhere in an entire organization regardless of initial placement. The result is for entities to work together in any team within an entire organizational structure worldwide, and still accumulate sales volume, group volume, achievements and recognition as a single entity rather than two distinct businesses. It also effectively allows entities to build organizations away from the entity that initially sponsored them into the organization. Rules are put into place to assure that the sponsor of any entity is benefited continually regardless of the re-entry cross-line placed income position, while also generating tracking data for those under whom the re-entry was placed. Placement therefore becomes fluid rather than ridged.

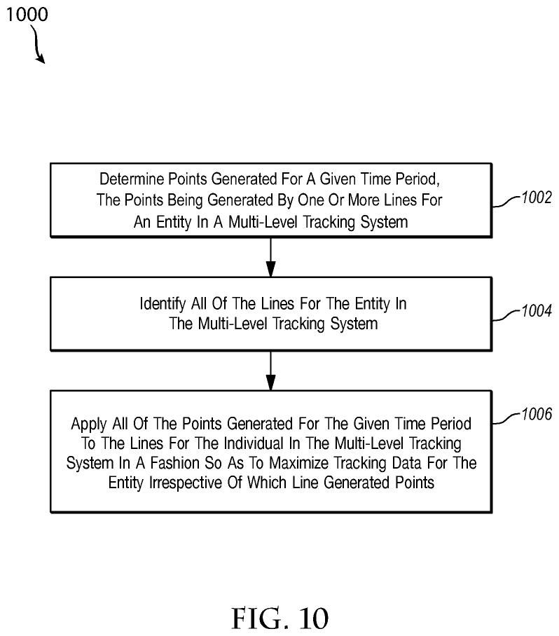

Referring now to FIG. 10, a method 1000 is illustrated. The method 1000 may be implemented using a computer system configured to track performance of multiple generations of robots and provide tracking data based on that performance and to optimize tracking data in such a performance tracking system. The method includes determining points generated for a given time period, the points being generated by one or more lines for an entity in a multi-level tracking system (act 1002). For example, FIGS. 3, 4, and 5 illustrate determining points generated by sales to preferred entities in a given period.

The method further includes identifying all of the lines for the entity in the multi-level tracking system (act 1004). Again, as illustrated in FIGS. 3, 4, and 5, different lines are identified. For example, in FIG. 3, power line 304 and payline 306 are identified.

The method further includes applying all of the points generated for the given time period to the lines for the entity in the multi-level tracking system in a fashion so as to maximize tracking data for the entity irrespective of which line generated tracking data (act 1006). Again, the examples illustrated in at least FIGS. 3-5 illustrate how this can be accomplished.

For example, the method 1000 may be implemented where applying all of the points generated for the given time period to the lines for the entity in the multi-level tracking system in a fashion so as to maximize tracking data for the entity includes applying points to one or more of the lines to earn a maximum reward on the one or more of the lines and dividing any remaining points as equally as possible among remaining lines that do not have sufficient points applied to have a maximum tracking data on those lines. Thus, for example, if the maximum reward is $2,000 per line, and tracking data are 15% of points, then the maximum number of points that should be applied to a line is 13,334. This can be performed so long as there are sufficient points to bring lines up to the maximum reward for that line. This may qualify an individual for additional bonuses for meeting certain maximums. Once there are no longer sufficient points to bring a line up to the maximum reward for that line, the points can be divided as equally as possible over the other lines.

Alternatively, the method 1000 may be practiced where applying all of the points generated for the given time period to the lines for the entity in the multi-level tracking system in a fashion so as to maximize tracking data for the entity includes applying points to one or more of the lines to earn a maximum reward on the one or more of the lines and applying one or more points to remaining lines that do not have sufficient points applied to have a maximum reward on those lines by, for each point applied to a remaining line, determining which line will generate the highest reward if the point is applied to that line. For example, this can be done by creating a hypothetical point or data distribution by distributing each given point on each line and determining the effect of the distribution on each line. Whichever distribution yields the highest commission will be made permanent and the point will be applied to that line.

The method 1000 may be practiced where the multi-level tracking and reward system is a system that has a predetermined maximum width or depth. The method may further include converting the multi-level tracking and reward system to a substantially unbounded system that does not have a predetermined limit of either width or depth by overlaying a representation of the multi-level tracking and reward system on the substantially unbounded system. For example, FIG. 6 illustrates unilevel, matrix, and binary bounded systems. As illustrated in FIG. 7, these systems can be converted to unbounded systems by overlaying them on an unbounded multi-line tracking and reward system.

The method 1000 may further include adding re-entry points for the entity into the multi-level tracking and reward system allowing the individual to have different points in the multi-level tracking and reward system for generating commissions. FIG. 8 illustrates an example where re-entry points have been added to a system. In some such embodiments, adding re-entry points for the entity into the multi-level tracking and reward system includes adding one or more re-entry points for the entity that do not pass through a single top point for the individual in a hierarchy for the multi-level tracking and reward system. An example of this is illustrated in FIG. 9.

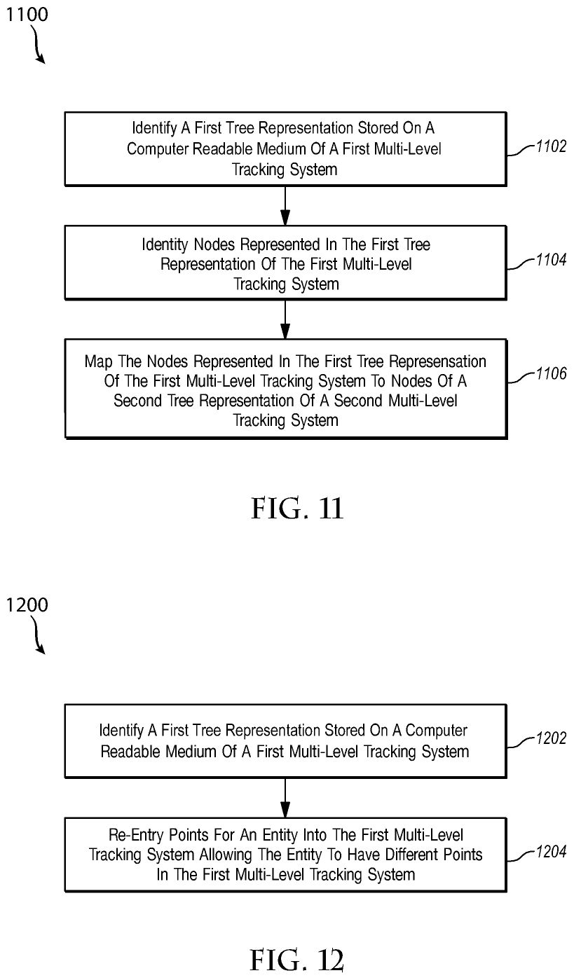

Referring now to FIG. 11, a method 1100 is illustrated. The method 1100 may be implemented by a computer system configured to optimize reward in a multi-level tracking and reward system. The method includes identifying a first tree representation stored on a computer readable medium of a first multi-level tracking and reward system (act 1102).

The method further includes identifying nodes represented in the first tree representation of the first multi-level tracking and reward system (act 1104).

The method further includes mapping the nodes represented in the first tree representation of the first multi-level tracking and reward system to nodes of a second tree representation of a second multi-level tracking and reward system (act 1106).

An example of the method 1100 is illustrated in the overlaying of multi-level tracking and reward systems illustrated in FIGS. 6 and 7.

The method 1100 may be practiced where the first multi-level tracking and reward system is a system that has a predetermined maximum width or depth and where the second multi-level tracking and reward system is a substantially unbounded system that has essentially an unbounded limit of either width or depth.

The method 1100 may further include adding re-entry points for an individual into the second multi-level tracking and reward system allowing the individual to have different points in the second multi-level tracking and reward system for generating commissions. As noted, examples of this are illustrated by FIG. 8. In some such embodiments, as illustrated by FIG. 9, adding re-entry points for the entity into the second multi-level tracking and reward system includes adding one or more re-entry points for the entity that do not pass through a single top point for the entity in a hierarchy for the second multi-level tracking and reward system.

The method 1100 may further include the following acts:

Determining points generated for a given time period, the points being generated by one or more lines for an entity in the second multi-level tracking and reward system; identifying all of the lines for the entity in the second multi-level tracking and reward system; and applying all of the points generated for the given time period to the lines for the entity in the second multi-level tracking and reward system in a fashion so as to maximize tracking data for the entity irrespective of which line generated points.

In some such embodiments, applying all of the points generated for the given time period to the lines for the entity in the second multi-level tracking and reward system in a fashion so as to maximize tracking data for the entity includes applying points to one or more of the lines to earn a maximum reward on the one or more of the lines and dividing any remaining points as equally as possible among remaining lines that do not have sufficient points applied to have a maximum tracking data on those lines. Alternatively or additionally, applying all of the points generated for the given time period to the lines for the individual in the second multi-level tracking and reward system in a fashion so as to maximize tracking data for the entity may include applying points to one or more of the lines to earn a maximum reward on the one or more of the lines and applying one or more points to remaining lines that do not have sufficient points applied to have a maximum reward on those lines by, for each point applied to a remaining line, determining which line will generate the highest reward if the point is applied to that line.

Referring now to FIG. 12, a method 1200 is illustrated. The method 1200 may be practiced by a computer system configured to optimize tracking data in a multi-level tracking and reward system. The method 1200 includes identifying a first tree representation stored on a computer readable medium of a first multi-level tracking and reward system (act 1202). The method 1200 further includes adding re-entry points for an entity into the first multi-level tracking and reward system allowing the entity to have different points in the first multi-level tracking and reward system for generating tracking data (act 1204).

The method 1200 may be practiced where adding re-entry points for the entity into the multi-level tracking and reward system includes adding one or more re-entry points for the entity that do not pass through a single top point for the entity in a hierarchy for the multi-level tracking and reward system.

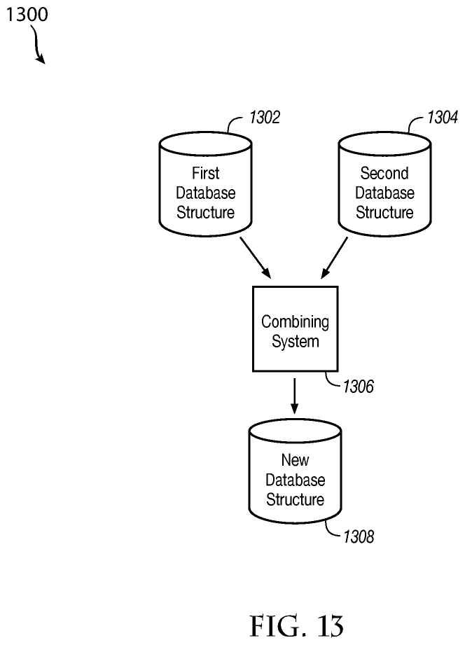

FIG. 13 illustrates a system 1300 which receives a first input a first database structure 1302 and the second database structure 1304. As noted above, each of these represents an electronic physical database structure that can represent a multigenerational tracking and rewarding system, for example to track and determine how well and initial robots can perform based on the performance of robots billed and deployed by the initial robots in one or more generations. The tracking and rewarding framework for different types of multigenerational reward systems results in databases being of a different structure. The combining system 1306 represents a computer system that is a special purpose computer system designed to receive electronic physical databases associated with different types of tracking and reward frameworks. The combining system 1306 is programmed to process the different types of database structures and to generate a new database structure 1308 that maintains the respective relationships between entities in the different generations and also to maintain the respective restrictions on the different types of frameworks of the originating database structure.

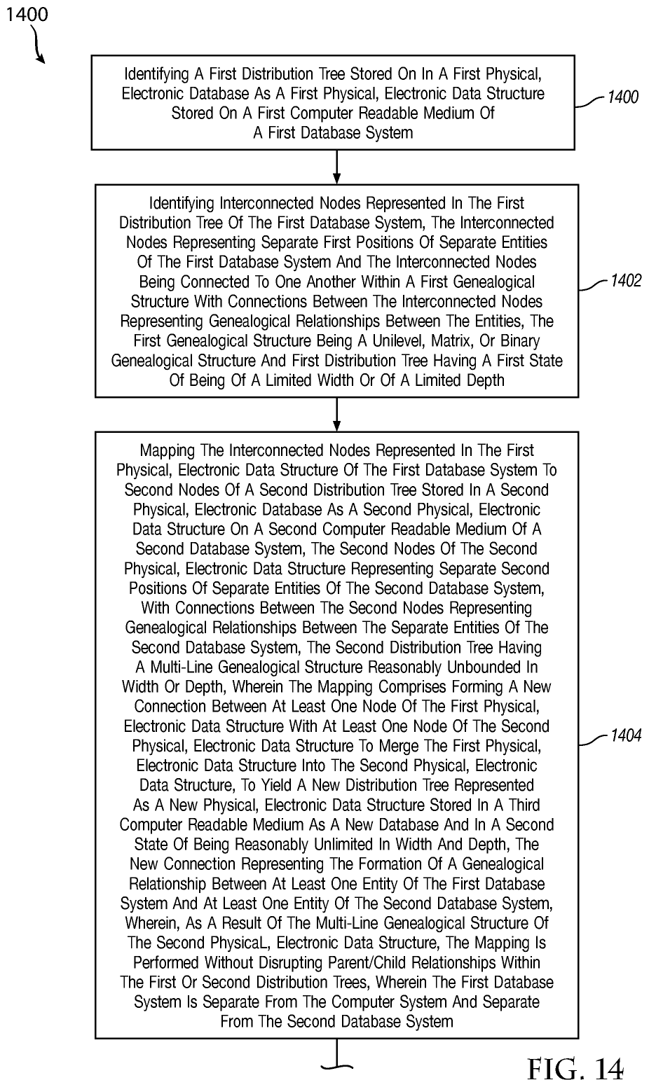

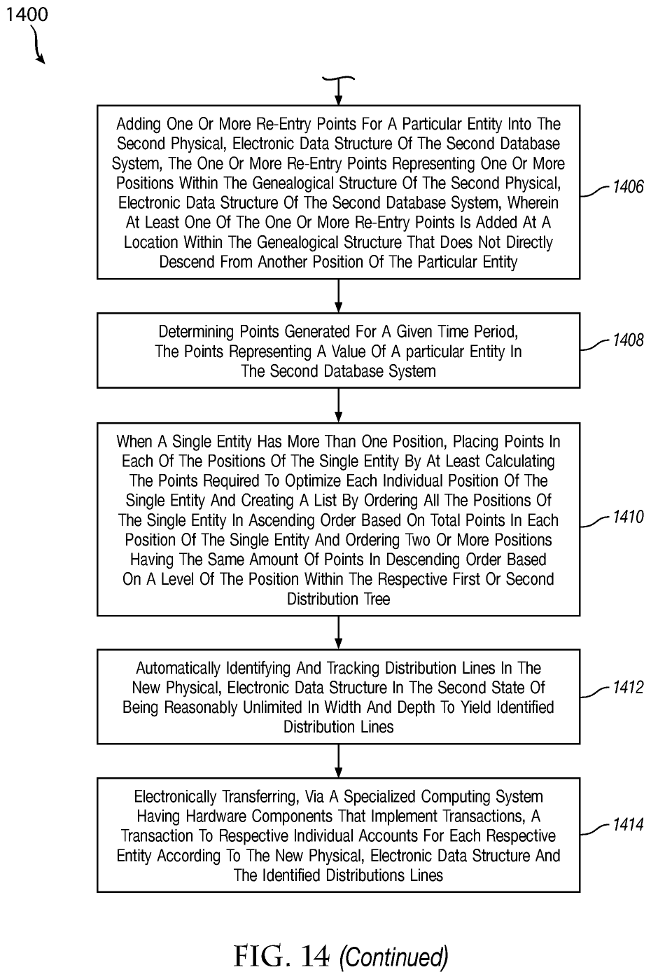

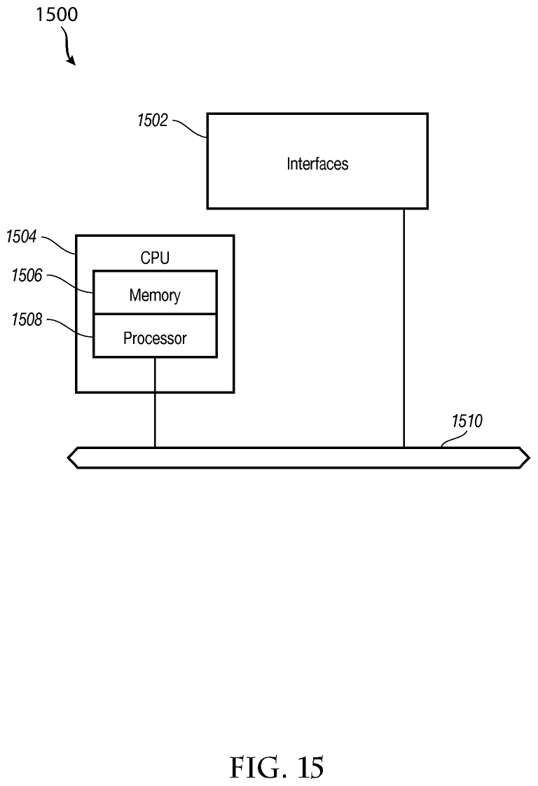

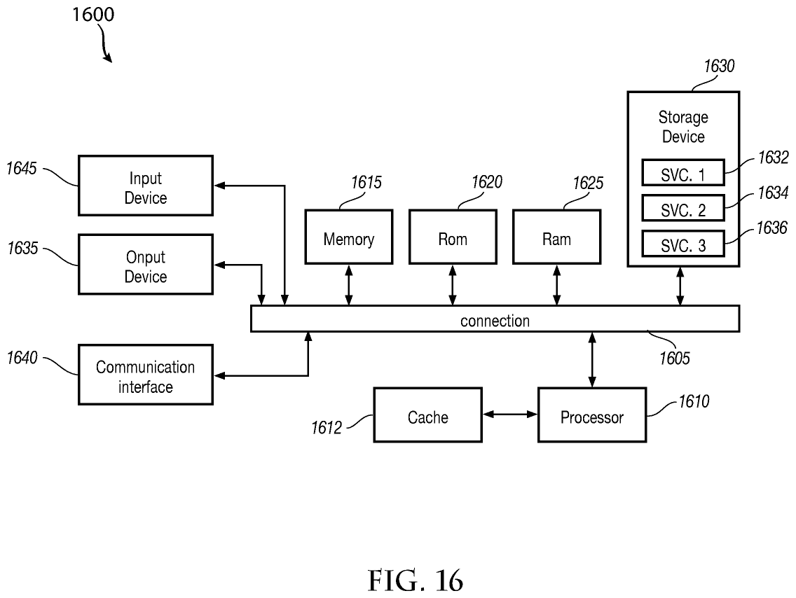

FIG. 14 illustrates a method aspect of this disclosure which can be performed by a special purpose computer system. As noted above, this method represents a specific approach that solves a problem in existing technological processes. Notably, when attempting to combine two different types or structures of tracking system databases as described above, there was no mechanism existing for blending these databases in such a way as to preserve the respective characteristics of the different tracking systems but to have them operational in a single database or system. This approach introduces a new way of combining disparate database types that enables a single system to operate and carry out both tracking systems operating with different requirements but within the same system.

An example method embodiment includes one or more of the steps of identifying a first tracking tree stored on in a first physical, electronic database as a first physical, electronic data structure stored on a first computer readable medium of a first database system (1402), identifying interconnected nodes represented in the first tracking tree of the first database system, the interconnected nodes representing separate first positions of separate entities of the first database system and the interconnected nodes being connected to one another within a first genealogical structure with connections between the interconnected nodes representing genealogical relationships between the entities, the first genealogical structure being a unilevel, matrix, or binary genealogical structure and first tracking tree having a first state of being of a limited width or of a limited depth (1402), mapping the interconnected nodes represented in the first physical, electronic data structure of the first database system to second nodes of a second tracking tree stored in a second physical, electronic database as a second physical, electronic data structure on a second computer readable medium of a second database system, the second nodes of the second physical, electronic data structure representing separate second positions of separate entities of the second database system, with connections between the second nodes representing genealogical relationships between the separate entities of the second database system, the second tracking tree having a multi-line genealogical structure reasonably unbounded in width or depth, wherein the mapping comprises forming a new connection between at least one node of the first physical, electronic data structure with at least one node of the second physical, electronic data structure to merge the first physical, electronic data structure into the second physical, electronic data structure, to yield a new tracking tree represented as a new physical, electronic data structure stored in a third computer readable medium as a new database and in a second state of being reasonably unlimited in width and depth, the new connection representing the formation of a genealogical relationship between at least one entity of the first database system and at least one entity of the second database system, wherein, as a result of the multi-line genealogical structure of the second physical, electronic data structure, the mapping is performed without disrupting parent/child relationships within the first or second tracking trees, wherein the first database system is separate from the computer system and separate from the second database system (1404).

A “node” can be an electronic, physical stored representation of an entity within a genealogical structure as part of the tracking trees and framework described herein.

The method can further include adding one or more re-entry points for a particular entity into the second physical, electronic data structure of the second database system, the one or more re-entry points representing one or more positions within the genealogical structure of the second physical, electronic data structure of the second database system, wherein at least one of the one or more re-entry points is added at a location within the genealogical structure that does not directly descend from another position of the particular entity (1406), determining points generated for a given time period, the points representing a value of a particular entity in the second database system (1408), when a single entity has more than one position, placing points in each of the positions of the single entity by at least calculating the points required to optimize each individual position of the single entity and creating a list by ordering all the positions of the single entity in ascending order based on total points in each position of the single entity and ordering two or more positions having the same amount of points in descending order based on a level of the position within the respective first or second tracking tree (1410), automatically identifying tracking lines in the new physical, electronic data structure in the second state of being reasonably unlimited in width and depth to yield identified tracking lines (1412) and electronically transferring, via a specialized computing system having hardware components that implement transactions, a transaction to respective individual accounts for each respective entity according to the new physical, electronic data structure and the identified tracking s lines (1414). In one aspect, the entity is a robot or robots and in another aspect, an entity could be a person or s distributor in a multi-level tracking and reward program.

Various embodiments and features associated with the creation and use of the multi-line tracking plans have been described above. It will be appreciated that these embodiments include the use of specialized computing systems having hardware (e.g., processors, memory, input and output devices) that are configured to process executable instructions that are accessed by or stored by the computing systems and that, when executed, implement the functionality described herein and which also extends to automatic identification, tracking and payment of tracking data for the tracking lines, as well as auto-mapping and generation of new multi-line tracking trees that correspond to existing tracking plans, and for performing the auto-balancing or any other functionality described herein.

To further emphasize the use of specialized computer systems, it will be appreciated that the present invention also extends to embodiments that include or utilize a special purpose or general-purpose computer including computer hardware, and physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes hardware storage devices such as RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other hardware medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions can include, for example, instructions and data which, when executed at a processor, such as a physical hardware processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts (which are implemented by a specialized computing system or network of computing systems), it is to be understood that the subject matter defined in the appended claims is not necessarily limited to the described features or acts described above. Rather, the described features and acts are disclosed as non-limiting examples of implementing the invention.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency are to be embraced within their scope.

I claim:

1. A computer system configured to efficiently combine two or more separate database systems into a single database system, the computer system comprising:
one or more physical processors; and
one or more computer hardware storage devices coupled to the one or more physical processors, the one or more hardware storage devices storing computer executable instructions that when executed by the one or more physical processors, yields a program module which performs operations comprising:
identifying a first tracking tree stored on in a first physical, electronic database as a first physical, electronic data structure stored on a first computer readable medium of a first database system;
identifying interconnected nodes represented in the first tracking tree of the first database system, the interconnected nodes representing separate first positions of separate entities of the first database system and the interconnected nodes being connected to one another within a first genealogical structure with connections between the interconnected nodes representing genealogical relationships between the separate entities, the first genealogical structure being a unilevel, matrix, or binary genealogical structure and first tracking tree having a first state of being of a limited width or of a limited depth;
mapping the interconnected nodes represented in the first physical, electronic data structure of the first database system to second nodes of a second tracking tree stored in a second physical, electronic database as a second physical, electronic data structure on a second computer readable medium of a second database system, the second nodes of the second physical, electronic data structure representing separate second positions of separate entities of the second database system, with connections between the second nodes representing genealogical relationships between the separate entities of the second database system, the second tracking tree having a multi-line genealogical structure unbounded in width or depth, wherein the mapping comprises forming a new connection between at least one node of the first physical, electronic data structure with at least one node of the second physical, electronic data structure to merge the first physical, electronic data structure into the second physical, electronic data structure, to yield a new tracking tree represented as a new physical, electronic data structure stored in a third computer readable medium as a new database and in a second state of being unlimited in width and depth, the new connection representing a formation of a genealogical relationship between at least one entity of the first database system and at least one entity of the second database system, wherein, as a result of the multi-line genealogical structure of the second physical, electronic data structure, the mapping is performed without disrupting parent/child relationships within the first tracking tree or the second tracking tree, wherein the first database system is separate from the computer system and separate from the second database system;
adding one or more re-entry points for a particular entity into the second physical, electronic data structure of the second database system, the one or more re-entry points representing one or more positions within the multi-line genealogical structure of the second physical, electronic data structure of the second database system, wherein at least one of the one or more re-entry points is added at a location within the multi-line genealogical structure that does not directly descend from another position of the particular entity;
determining points generated for a given time period, the points representing a value of a particular entity in the second database system;
when a single entity has more than one position, placing points in each of the positions of the single entity by at least calculating the points required to optimize each individual position of the single entity and creating a list by ordering all the positions of the single entity in ascending order based on total points in each position of the single entity and ordering two or more positions having the same amount of points in descending order based on a level of the position within the respective first or second tracking tree; and
automatically identifying and tracking tracking lines in the new physical, electronic data structure in the second state of being unlimited in width and depth to yield identified tracking lines.

2. The computer system of claim 1, wherein the entities comprise one or more of robots each having individual associated accounts or individuals who are members of a multi-level tracking program.

3. The computer system of claim 1, wherein the computer system further comprises computer executable instructions that when executed by the one or more physical processors cause a performance of operations further comprising:
identifying all tracking lines descending from a particular position of a particular entity in the second database system; and
applying all of the points generated for the given time period to the tracking lines for the particular entity in the second database system in a fashion so as to maximize tracking data for the particular entity irrespective of which tracking lines generated the tracking data.

4. The computer system of claim 1, wherein applying all of the tracking data generated for the given time period to the tracking lines for the particular entity in the second database system in a fashion so as to maximize tracking data for the particular entity irrespective of which entity line generated tracking data comprises applying tracking data to one or more of the tracking lines to earn tracking data based on optimizing the one or more of the tracking lines and dividing any remaining tracking data as equally as possible among remaining tracking lines obtain a maximum amount of tracking data on those lines.

5. The computer system of claim 1, wherein applying all of the tracking data generated for the given time period to the tracking lines for the particular entity in the second database system in a fashion so as to maximize tracking data for the particular entity irrespective of which tracking line generated tracking data comprises applying tracking data to one or more of the tracking lines to earn tracking data based on optimizing the one or more of the tracking lines and applying one or more tracking data to remaining tracking lines that have not been optimized by, for each tracking data applied to a remaining tracking line, determining which tracking line will generate the highest tracking data if the tracking data is applied to that tracking line.

6. The computer system of claim 1, wherein the computer system further comprises computer executable instructions that when executed by the one or more physical processors cause a performance of operations further comprising:
providing performance data associated with a performance of individual entities according to the new physical, electronic data structure and the identified tracking lines.

7. A computer system configured to efficiently combine two or more separate database systems into a single database system, the computer system comprising:
means for identifying a first tracking tree stored on in a first physical, electronic database as a first physical, electronic data structure stored on a first computer readable medium of a first database system;
means for identifying interconnected nodes represented in the first tracking tree of the first database system, the interconnected nodes representing separate positions of separate entities of the first database system and the interconnected nodes being connected to one another within a first genealogical structure with connections between the interconnected nodes representing genealogical relationships between the separate entities, the first genealogical structure being a unilevel, matrix, or binary genealogical structure and first tracking tree having a first state of being of a limited width or of a limited depth;
means for mapping the interconnected nodes represented in the first physical, electronic data structure of the first database system to second nodes of a second tracking tree stored in a second physical, electronic database as a second physical, electronic data structure on a second computer readable medium of a second database system, the second nodes of the second physical, electronic data structure representing separate income positions of separate entities of the second database system, with connections between the second nodes representing genealogical relationships between the separate entities of the second database system, the second tracking tree having a multi-line genealogical structure unbounded in width or depth, wherein the mapping comprises forming a new connection between at least one node of the first physical, electronic data structure with at least one node of the second physical, electronic data structure to merge the first physical, electronic data structure into the second physical, electronic data structure, to yield a new tracking tree represented as a new physical, electronic data structure stored as a new database in a third computer readable medium and in a second state of being unlimited in width and depth, the new connection representing a formation of a genealogical relationship between at least one entity of the first database system and at least one entity of the second database system, wherein, as a result of the multi-line genealogical structure of the second physical, electronic data structure, the mapping is performed without disrupting parent/child relationships within the first tracking tree or the second tracking tree, wherein the first database system is separate from the computer system and separate from the second database system;
means for adding one or more re-entry points for a particular entity into the second physical, electronic data structure of the second database system, the one or more re-entry points representing one or more income positions within the genealogical structure of the second physical, electronic data structure of the second database system, wherein at least one of the one or more re-entry points is added at a location within the genealogical structure that does not directly descend from another income position of the particular entity;
means for determining points generated for a given time period, the points representing a value of a particular entity in a second multi-level tracking system;
means for placing tracking data in each of the tracking positions of the single entity by at least calculating the tracking data required to optimize each individual tracking position of the single entity and creating a list by ordering all the positions of the single entity in ascending order based on total tracking data in each income position of the single entity and ordering two or more tracking positions having the same amount of tracking data in descending order based on a level of the tracking position within the first tracking tree or the second tracking tree; and
means for automatically identifying and following tracking lines in the new physical, electronic data structure in the second state of being unlimited in width and depth to yield identified tracking lines.

8. The computer system of claim 7, further comprising:
means for providing tracking data to respective individual entities according to the new physical, electronic data structure and the identified tracking lines.

9. The computer system of claim 7, wherein the entities comprise one or more of robots each having associated accounts or individuals who are members of a multi-level tracking program.
